(19) United States
(12) Patent Application Publication
(10) Pub. No.: US 2018/0304705 A1
(43) Pub. Date: Oct. 25, 2018

(54) Adjustment structure of Presta valve for bicycle tire

(71) Applicant: Chang Hui LIN, Hsiu Shu (TW)

(72) Inventor: Chang Hui LIN, Hsiu Shu (TW)

(21) Appl. No.: 15/490,922

(22) Filed: Apr. 19, 2017

(51) Int. Cl. B60C 29/00; F16K 31/46

(52) U.S. Cl. CPC B60C 29/005; B60C 2200/12; F16K 31/46

(57) ABSTRACT

An adjustment structure of a Presta valve for a bicycle tire contains: an outer stem, a reinforcement stem, and a fitting sleeve. The outer stem includes a flat extension extending outward from a bottom of the outer stem, and the outer stem includes a coupling portion formed on the bottom of the outer stem. The reinforcement stem includes a hollow portion defined in the reinforcement stem, and the reinforcement stem includes a female threaded portion arranged on an inner wall of a bottom of the reinforcement stem. The fitting sleeve includes multiple ribs arranged on an upper end of an outer wall of the fitting sleeve. Furthermore, the fitting sleeve further includes a recess defined on a lower end of the outer wall thereof so as to retain with the flat extension of the outer stem.

### FIELD OF THE INVENTION

The present invention relates to an adjustment structure of a Presta valve which adjusts a pressure of a bicycle tire quickly.

### BACKGROUND OF THE INVENTION

A conventional adjustment structure of a Presta valve is applied to adjust pressure of a bicycle tire. A wheel rim is made of carbon fiber and is in connection with a wheel frame so as to increase reinforcement of the wheel rim. However, a length of the Presta valve is fixed, so the Presta valve cannot extend out of a wheel spoke, and a pressure of the bicycle tire cannot be adjusted randomly.

The present invention has arisen to mitigate and/or obviate the afore-described disadvantages.

### SUMMARY OF THE INVENTION

The primary objective of the present invention is to provide an adjustment structure of a Presta valve which adjusts a pressure of a bicycle tire quickly.

To obtain above-mentioned objective, an adjustment structure of a Presta valve for a bicycle tire provided by the present invention contains: an outer stem, a reinforcement stem, and a fitting sleeve.

The outer stem includes a flat extension extending outward from a bottom of the outer stem, and the outer stem includes a coupling portion formed on the bottom of the outer stem.

The reinforcement stem includes a hollow portion defined in the reinforcement stem, and the reinforcement stem includes a female threaded portion arranged on an inner wall of a bottom of the reinforcement stem.

The fitting sleeve includes multiple ribs arranged on an upper end of an outer wall of the fitting sleeve. Furthermore, the fitting sleeve further includes a recess defined on a lower end of the outer wall thereof so as to retain with the flat extension of the outer stem.

### BRIEF DESCRIPTION OF THE DRAWINGS

FIG. 1 is a perspective view showing the exploded components of an adjustment structure of a Presta valve for a bicycle tire according to a preferred embodiment of the present invention.

FIG. 2 is a perspective view showing the assembly of the adjustment structure of the Presta valve for the bicycle tire according to the preferred embodiment of the present invention.

FIG. 3 is a cross sectional view showing the operation of the adjustment structure of the Presta valve for the bicycle tire according to the preferred embodiment of the present invention.

FIG. 4 is another cross sectional view showing the operation of the adjustment structure of the Presta valve for the bicycle tire according to the preferred embodiment of the present invention.

FIG. 5 is a perspective view showing the application of the adjustment structure of the Presta valve for the bicycle tire according to the preferred embodiment of the present invention.

FIG. 6 is a cross sectional view showing the application of the adjustment structure of the Presta valve for the bicycle tire according to the preferred embodiment of the present invention.

FIG. 7 is a cross sectional view showing the application of a part of the adjustment structure of the Presta valve for the bicycle tire according to the preferred embodiment of the present invention.

### DETAILED DESCRIPTION OF THE PREFERRED EMBODIMENTS

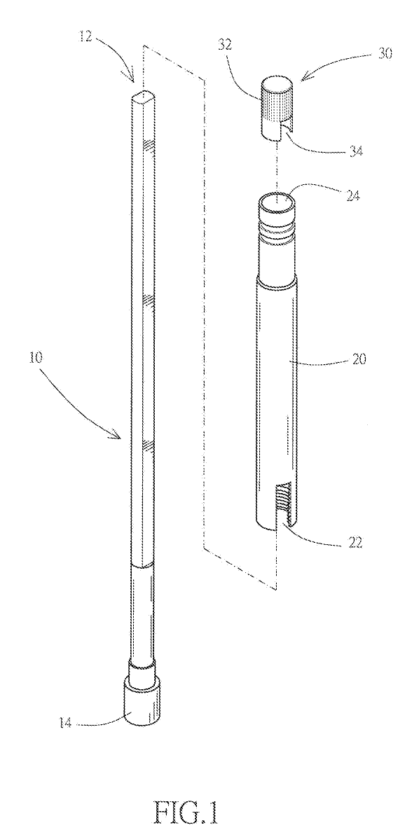

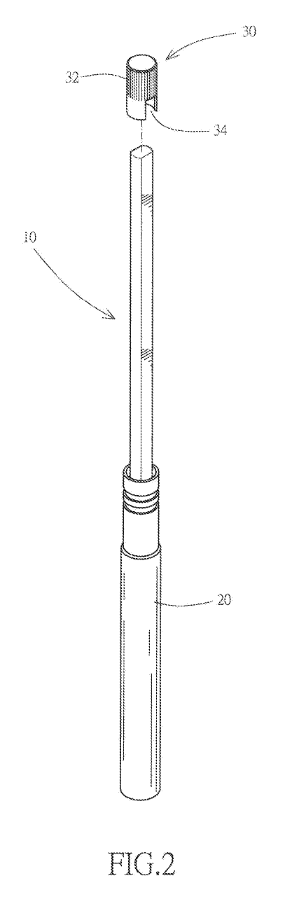

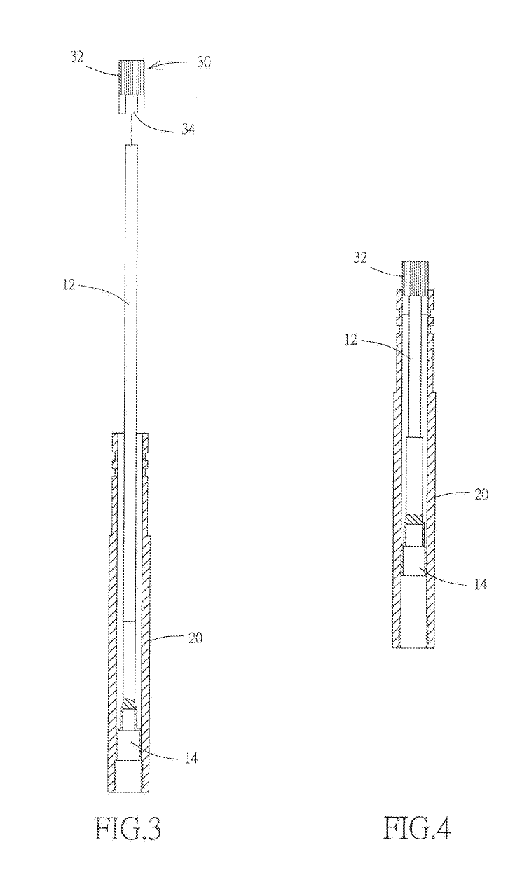

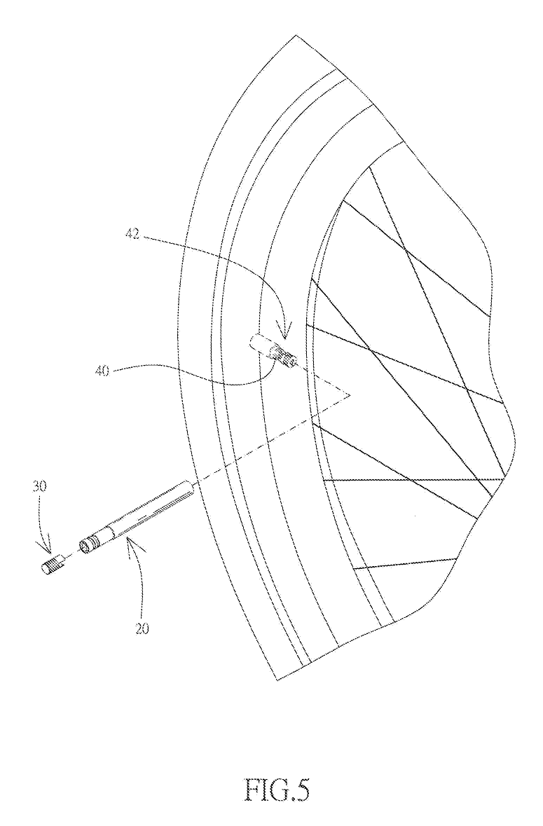

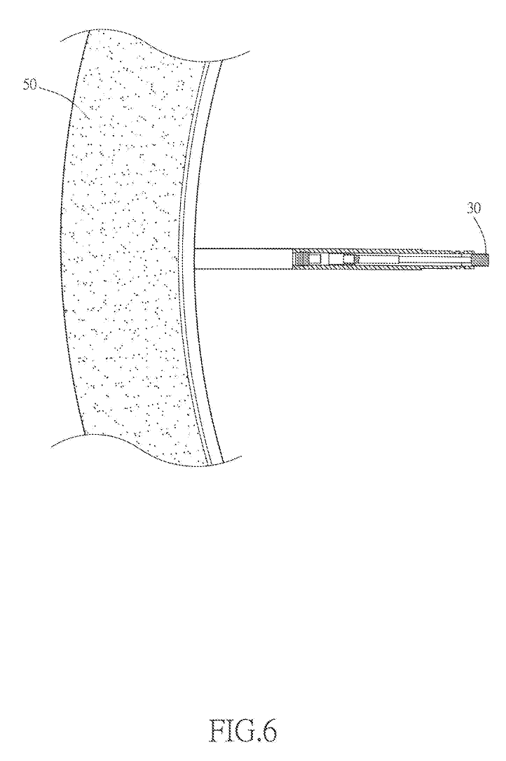

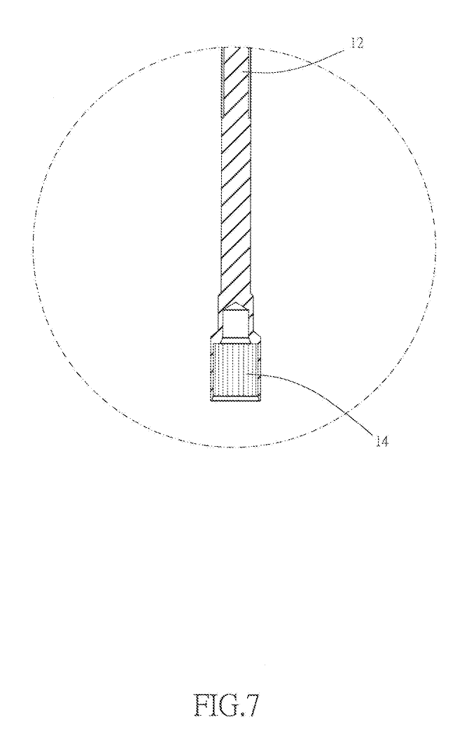

With reference to FIGS. 1-7, an adjustment structure of a Presta valve 40 for a bicycle tire 50 according to a preferred embodiment of the present invention comprises: an outer stem 10, a reinforcement stem 20, and a fitting sleeve 30.

The outer stem 10 includes a flat extension 12 extending outward from a bottom thereof and includes a coupling portion 14 formed on the bottom of the outer stem 10.

The reinforcement stem 20 includes a hollow portion 24 defined therein and includes a female threaded portion 22 arranged on an inner wall of a bottom thereof.

The fitting sleeve 30 includes multiple ribs 32 arranged on an upper end of an outer wall thereof and includes a recess 34 defined on a lower end of the outer wall of the fitting sleeve 30.

As fitting the flat extension 12 into the hollow portion 24 of the reinforcement stem 20, a part of the flat extension 12 of the outer stem 10 is cut so that a length of the flat extension 12 is equal to a length of the reinforcement stem 20. Thereafter, the fitting sleeve 30 is fitted into the hollow portion 24 of the reinforcement stem 20, and the recess 34 of the fitting sleeve 30 retains with the flat extension 12 of the outer stem 10.

In operation, the outer stem 10 is fitted into the hollow portion 24 of the reinforcement stem 20, and the coupling portion 14 of the outer stem 10 is fitted onto the Presta valve 40 on the bicycle tire 50. In the meantime, the female threaded portion 22 of the reinforcement stem 20 screws with a male threaded portion 42 of the Presta valve 40, hence the fitting sleeve 30 is rotated so that the multiple ribs 32 drive the flat extension 12 of the outer stem 10 to rotate, and the coupling portion 14 of the outer stem 10 drives the Presta valve 40 to adjust a pressure of the bicycle tire 50 quickly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. An adjustment structure of a Presta valve for a bicycle tire comprising:
an outer stem including a flat extension extending outward from a bottom of the outer stem, and the outer stem including a coupling portion formed on the bottom of the outer stem;
a reinforcement stem including a hollow portion defined in the reinforcement stem, and the reinforcement stem including a female threaded portion arranged on an inner wall of a bottom of the reinforcement stem; and
a fitting sleeve including multiple ribs arranged on an upper end of an outer wall of the fitting sleeve;
wherein the fitting sleeve further includes a recess defined on a lower end of the outer wall thereof so as to retain with the flat extension of the outer stem;
wherein the flat extension is fitted into the hollow portion of the reinforcement stem, a part of the flat extension of the outer stem is cut so that a length of the flat extension is equal to a length of the reinforcement stem, thereafter the fitting sleeve is fitted into the hollow portion of the reinforcement stem, and the recess of the fitting sleeve retains with the flat extension of the outer stem;
wherein the outer stem is fitted into the hollow portion of the reinforcement stem, and the coupling portion of the outer stem is fitted onto the Presta valve on the bicycle tire, in the meantime, the female threaded portion of the reinforcement stem screws with a male threaded portion of the Presta valve, hence the fitting sleeve is rotated so that the multiple ribs drive the flat extension of the outer stem to rotate, and the coupling portion of the outer stem drives the Presta valve to adjust a pressure of the bicycle tire.

2. (canceled)
